(19) United States
(12) Patent Application Publication
(10) Pub. No.: US 2019/0227217 A1
(43) Pub. Date: Jul. 25, 2019

(54) CLOCK STRUCTURE ENABLING HIGHLY UNIFORM DISTRIBUTION OF ILLUMINATING LIGHT

(71) Applicant: TSUEN JER ENTERPRISE CO., LTD., Taipei City (TW)

(72) Inventor: YUNG-MIN LIN, TAIPEI CITY (TW)

(21) Appl. No.: 16/029,746

(22) Filed: Jul. 9, 2018

(30) Foreign Application Priority Data
Jan. 25, 2018 (CN) 201820125730.8

(51) Int. Cl. F21V 8/00; G04B 19/30

(52) U.S. Cl. CPC G02B 6/0051; G02B 6/0073; G04B 19/30; G02B 6/0068; G02B 6/0065

(57) ABSTRACT

A clock structure enabling highly uniform distribution of illuminating light includes a case frame, a dial, a movement having a shaft extended through the dial, and a set of hands connected to the movement shaft. The clock structure further includes a round acrylic plate located below the dial and having an annular blind groove formed around a peripheral area, a sheet of light uniforming paper attached to an upper surface of the acrylic plate, a silk-screen printing ink layer formed on a lower surface of the acrylic plate, a flexible circuit board mounted in the blind groove, and LED lights equally spaced on the circuit board to emit light toward a radially inner surface of the blind groove. The silk-screen printing ink layer diffusely reflects the light and the light uniforming paper enables uniform distribution of the light over the dial to make the clock structure a high-end product.

### CROSS-REFERENCE TO RELATED APPLICATION

This non-provisional application claims priority under 35 U.S.C. § 119(a) on Patent Application No(s). 201820125730.8 filed in China on Jan. 25, 2018, the entire contents of which are hereby incorporated by reference.

### FIELD OF THE INVENTION

The present invention relates to a clock structure, and more particularly, to a clock structure that enables highly uniform distribution of illuminating light, so that illuminating light produced by the clock structure can cover the entire dial thereof and the power consumption the clock structure is not high.

### BACKGROUND OF THE INVENTION

Clock structures are well-known among people. Generally, a clock structure includes a set of hands, a dial, a movement and a case frame. The hands, the dial and the movement are located in the case frame, while the hands and the movement are located at a front and a rear side of the dial, respectively. The dial is provided at a center with a through hole, via which a shaft of the movement is extended to the front side of the dial to connect to the hands.

For a user to conveniently check current time in the night time, the clock structure can be further provided with illuminating lights. The currently commercially available clock structures are usually provided with one or more illuminating lights. Basically, the illuminating light or lights can only illuminate some areas of the dial. In other words, the dial illuminated by the illuminating light or lights has some brighter areas and some darker areas, which disadvantageously prevents the user from easily checking the current time in the night time and inevitably adversely affects the quality level of the whole clock structure, preventing it from being a high-end product.

It is therefore tried by the inventor to develop a clock structure enabling highly uniform distribution of illuminating light, in order to overcome the disadvantage of the prior art clock structures.

### SUMMARY OF THE INVENTION

A primary object of the present invention is to provide a clock structure that enables highly uniform distribution of illuminating light, so that illuminating light produced by the clock structure can uniformly spread over the entire dial, which not only enables a user to conveniently check the current time in the night time but also largely upgrades the quality level of the whole clock structure for the same to be a high-end product.

To achieve the above and other objects, the clock structure enabling highly uniform distribution of illuminating light provided according to the present invention includes a case frame, a dial having a centered first through hole, a movement having a shaft extended through the first through hole, and a set of hands connected to the movement shaft.

The clock structure of the present invention further includes an acrylic plate located below the dial, a sheet of light uniforming paper attached to an upper surface of the acrylic plate, a silk-screen printing ink layer formed on a lower surface of the acrylic plate, a circuit board and a plurality of LED lights. The acrylic plate is a round disc in shape and is provided on the upper surface along a radially inner peripheral area with an annular blind groove, which has a bottom surface, an annular radially outer wall surface and an annular radially inner wall surface. The circuit board is a flexible long strip in shape, on along which the LED lights are mounted and equally spaced. The circuit board is attached to the annular radially outer wall surface of the annular blind groove to form a round ring, such that the LED lights emit light toward the annular radially inner wall surface of the annular blind groove. The silk-screen printing ink layer is a white ink layer formed on the lower surface of the acrylic plate by way of silk-screen printing.

Further, the white ink layer includes a plurality of mutually independent round ink dots, which are arranged in an array.

Further, the acrylic plate and the light uniforming paper are formed at a central area with a second through hole and a third through hole, respectively, to correspond to the first through hole on the dial.

Further, a sheet of rigid polypropylene (PP) synthetic paper is provided between the case frame and the acrylic plate. The rigid PP synthetic paper has a white upper surface and is provided at a central area with a fourth through hole corresponding to the first through hole.

Further, the circuit board has a positive wire, a negative wire and a plurality of branch circuits provided thereon. The branch circuits are connected in parallel and therefore have the same voltage across them; and the branch circuits respectively include one LED light and one resistor connected to the LED light in series.

In summary, the clock structure according to the present invention utilizes an acrylic plate that has relatively good light transmittance and is provided on an upper surface along a radially inner peripheral area with an annular blind groove, in which a substantially ring-shaped circuit board is mounted, such that a plurality of LED lights equally spaced on along the circuit board radially inward emit light toward an interior of the acrylic plate. The light emitted by the LED lights is diffusely reflected by a plurality of round ink dots arrayed on a silk-screen printing ink layer formed on a lower surface of the acrylic plate, and a light uniforming paper attached to an upper surface of the acrylic plate further brings the diffusely reflected light to uniformly distribute over the entire dial, so that a surface light source can be formed to achieve an overall luminous effect on the dial of the clock structure.

Compared to the existing clock techniques, the clock structure of the present invention includes LED lights that are set in the acrylic plate and annularly spaced, a silk-screen printing ink layer that can diffusely reflect light and a light uniforming paper that enables uniform distribution of light, so that the light emitted by the LED lights can uniformly pass through the dial, making the clock a high-end product.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein FIG. 1 is an exploded perspective view of a clock structure enabling highly uniform distribution of illuminating light according to a preferred embodiment of the present invention;

FIG. 2 is a perspective structural view of an acrylic plate used in the clock structure according to the present invention;

FIG. 3 shows a silk-screen printing ink layer used in the clock structure of the present invention has a plurality of round ink dots distributed thereon;

FIG. 4 is a structural view showing the acrylic plate of FIG. 2 is assembled to a case frame of the clock structure of the present invention;

FIG. 5 is a sectional view showing the acrylic plate of FIG. 2 has a rigid PP synthetic paper located at a lower side thereof;

FIG. 6 is an enlarged view of the circled area A of FIG. 5; and

FIG. 7 is a structural view of a circuit board used in the clock structure of the present invention.

In the drawings, reference numeral 1 denotes a case frame; 2 denotes an acrylic plate; 21 denotes a silk-screen printing ink layer; 211 denotes round ink dots; 22 denotes an annular blind groove; 221 denotes a bottom surface of the blind groove; 222 denotes an annular radially outer wall surface of the blind groove; 223 denotes an annular radially inner wall surface of the blind groove; 23 denotes a second through hole; 3 denotes a sheet of light uniforming paper; 31 denotes a third through hole; 4 denotes a circuit board; 41 denotes a positive wire; 42 denotes a negative wire, 43 denotes branch circuits; 44 denotes resistors, 5 denotes a sheet of rigid PP synthetic paper; 51 denotes a fourth through hole; and 6 denotes LED lights.

### DETAILED DESCRIPTION OF THE PREFERRED EMBODIMENTS

The present invention will now be described with a preferred embodiment thereof and by referring to the accompanying drawings.

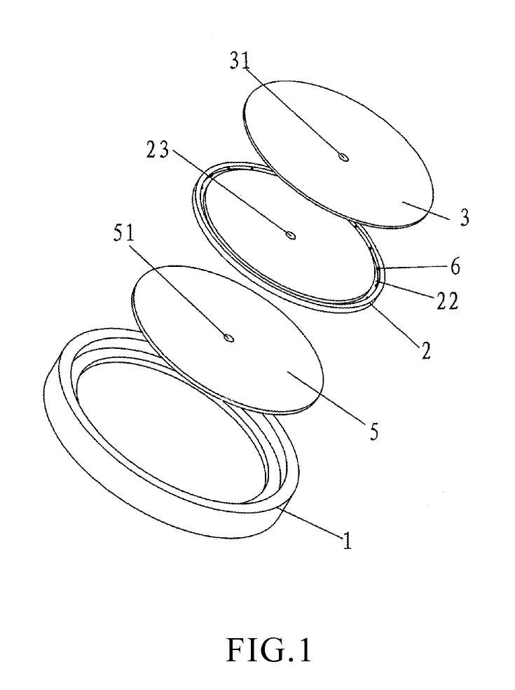

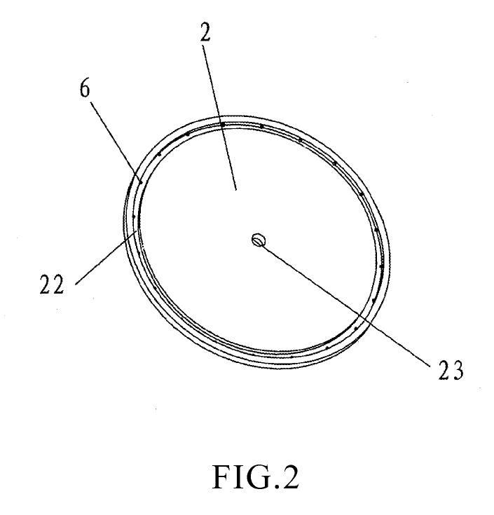

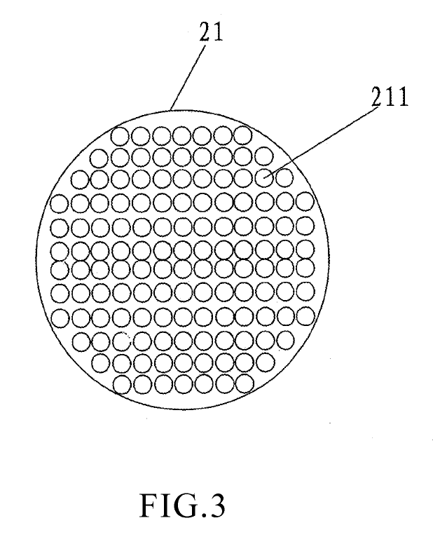

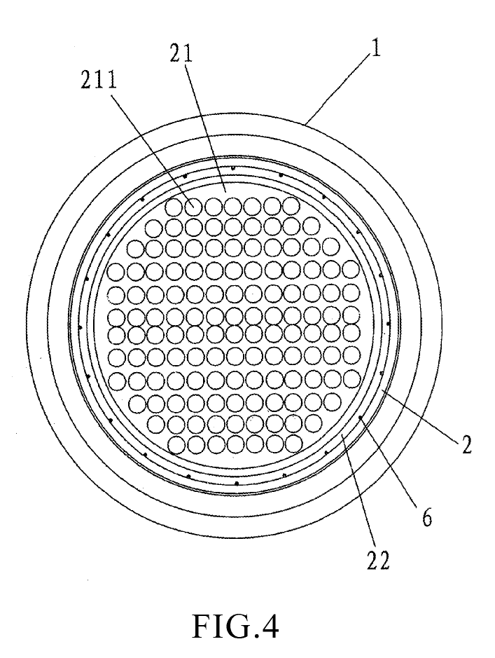

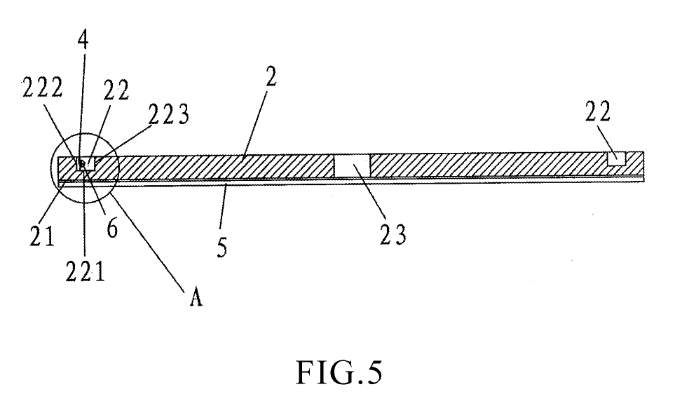

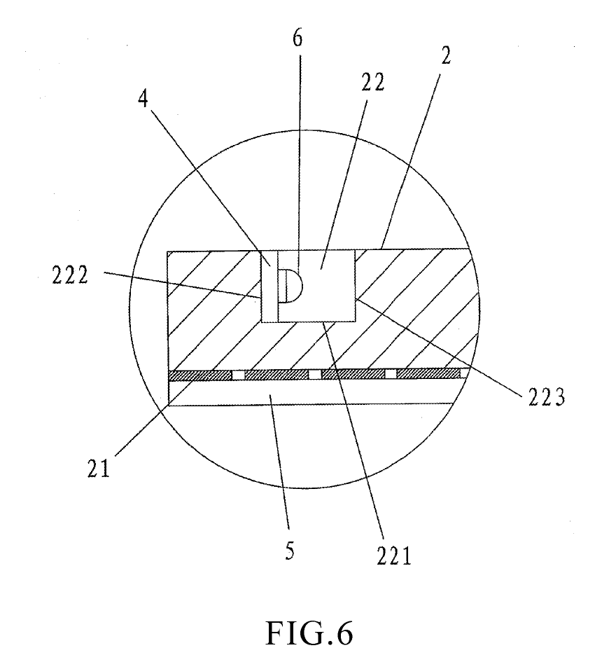

Please refer to FIGS. 1 to 7, in which a clock structure enabling highly uniform distribution of illuminating light according to a preferred embodiment of the present invention is shown. For the purpose of conciseness and clarity, the present invention is also briefly referred to as the clock structure herein. The clock structure of the present invention includes a case frame 1, in which a dial (not shown), a set of hands (not shown) and a movement (not shown) are provided. The dial is provided at a center thereof with a first through hole (not shown), via which a shaft of the movement is extended to a front side of the dial to connect to the hands of the clock structure.

The clock structure of the present invention further includes an acrylic plate 2, a sheet of light uniforming paper 3, a silk-screen printing ink layer 21, a circuit board 4, and a plurality of light-emitting-diode (LED) lights 6. The light uniforming paper 3 is attached to an upper surface of the acrylic plate 2. The acrylic plate 2 is a round disc in shape and located below the dial, and is provided on the upper surface along a radially inner peripheral area with an annular blind groove 22, which has a bottom surface 221, an annular radially outer wall surface 222, and an annular radially inner wall surface 223. The circuit board 4 is in the form of a flexible long strip, on and along which the LED lights 6 are mounted and equally spaced. The circuit board 4 is attached to the annular radially outer wall surface 222 to form a round ring. The LED lights 6 emit light toward the annular radially inner wall surface 223. Since the acrylic plate 2 has relatively good light transmittance, the light emitted by the LED lights 6 and projected onto the acrylic plate 2 can pass through the acrylic plate 2 and be projected onto the dial, which is located above the acrylic plate 2, so that a user can clearly see the hands located above the dial of the clock structure to know the current time. The silk-screen printing ink layer 21 is a white ink layer formed on a lower surface of the acrylic plate 2 by silk-screen printing. When the LED lights 6 uniformly emit light from the annular blind groove 22 around the peripheral edge of the acrylic plate 2 and the emitted light is projected onto the lower surface of the acrylic plate 2 and accordingly, the white ink layer 21 formed on the lower surface of the acrylic plate 2, the light is reflected and diffusely reflected from the white ink layer 21 and be effectively projected onto the dial above the acrylic plate 2, bringing the light to more uniformly distribute over the entire dial. Further, with the light uniforming effect provided by the light uniforming paper 3 attached to the upper surface of the acrylic plate 2, the light emitted by the LED lights 6 projected on the dial is highly uniformly distributed over the dial, allowing uniform brightness to present over the entire dial, which enables a user to clearly see the time shown on the dial even in the night time. In summary, the clock structure of the present invention enables the forming of a surface light source to achieve an overall luminous effect. Thus, the present invention overcomes the prior art luminous clock problem of having some brighter and some darker areas on the dial and thereby largely upgrades the quality of the whole clock and make the clock a high-end product in the market to meet the demand of high-end consumers.

Preferably, the white ink layer 21 includes a plurality of mutually independent round ink dots 211, which are arranged in an array. These round ink dots 211 reflect and diffusely reflect the light emitted by the LED lights 6, bringing the light from the LED lights 6 to be more evenly projected onto the dial. Further, with the round ink dots 211 being arranged in an array, the light being reflected and diffusely reflected from the arrayed round ink dots 211 can be more uniformly projected onto the dial.

Preferably, the acrylic plate 2 and the light uniforming paper 3 are formed at a central area with a second through hole 23 and a third through hole 31, respectively, to correspond to the first through hole (not shown) on the dial, so that the movement shaft can be extended through the second and the third through hole 23, 31 to connect to the hands of the clock structure and drive the latter to rotate.

Preferably, a sheet of rigid polypropylene (PP) synthetic paper 5 is provided between the case frame 1 and the acrylic plate 2. The rigid PP synthetic paper 5 has a white upper surface, which is able to reflect the light emitted by all the LED lights 6 onto the dial. In the event the rigid PP synthetic paper 5 has an upper surface in a color other than white color, part of the light emitted by the LED lights 6 will be absorbed by the rigid PP synthetic paper 5, and the reflected light shall be in a color the same as that of the rigid PP synthetic paper 5. Therefore, the use of the rigid PP synthetic paper 5 having a white upper surface will effectively reflect all the light emitted by the LED lights 6 to avoid not only loss of light, but also loss of light energy that occurs when the light passes through the acrylic plate 2. Therefore, with the above arrangements, only a relatively low energy is needed to lighten the LED lights 6, while the brightness of the dial irradiated by the LED lights 6 is largely increased, allowing a user to more clearly view the current time shown on the clock structure of the present invention in the night time. The rigid PP synthetic paper 5 is provided at a central area with a fourth through hole 51 corresponding to the first through hole of the dial. The movement shaft is also extended through the fourth through hole 51 to connect to the hands of the clock structure.

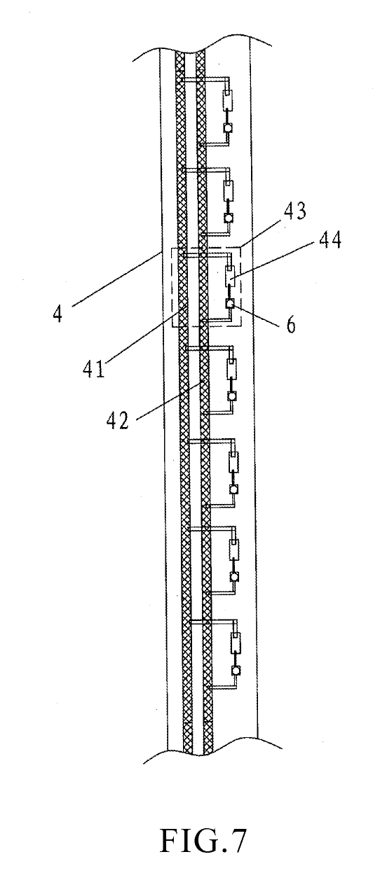

Preferably, as shown in FIG. 7, the circuit board 4 has a positive wire 41, a negative wire 42 and a plurality of branch circuits 43. The branch circuits 43 are connected in parallel and therefore have the same voltage across them. The branch circuits 43 respectively include one LED light 6 and one resistor 44 connected to the LED light 6 in series, and therefore, the LED lights 6 in the branch circuits 43 have the same brightness. With these arrangements, it is able to avoid non-uniform LED light brightness due to different voltages, which causes the problem of showing different brightness in different areas on the dial irradiated by the LED lights 6, as found in the prior art luminous clock structures. In this manner, the clock structure of the present invention effectively ensures the effect of highly uniform distribution of illuminating light and enables lowered power consumption of the LED lights.

The present invention has been described with a preferred embodiment thereof and it is understood that the preferred embodiment is only illustrative and not intended to limit the present invention in any way and many changes and modifications in the described embodiment can be carried out without departing from the scope and the spirit of the invention that is intended to be limited only by the appended claims.

What is claimed is:

1. A clock structure enabling highly uniform distribution of illuminating light, comprising a case frame, a dial having a centered first through hole, a movement having a shaft extended through the first through hole, and a set of hands connected to the movement shaft; characterized in that the clock structure further includes an acrylic plate located below the dial, a sheet of light uniforming paper attached to an upper surface of the acrylic plate, a silk-screen printing ink layer formed on a lower surface of the acrylic plate, a circuit board and a plurality of LED lights;
the acrylic plate being a round disc in shape and being provided on the upper surface along a radially inner peripheral area with an annular blind groove, which has a bottom surface, an annular radially outer wall surface and an annular radially inner wall surface;
the circuit board being a flexible long strip in shape, on along which the LED lights are mounted and equally spaced; the circuit board being attached to the annular radially outer wall surface of the annular blind groove to form a round ring, such that the LED lights mounted on the circuit board emit light toward the annular radially inner wall surface of the annular blind groove; and
the silk-screen printing ink layer being a white ink layer formed on the lower surface of the acrylic plate by way of silk-screen printing.

2. The clock structure enabling highly uniform distribution of illuminating light as claimed in claim 1, characterized in that the white ink layer includes a plurality of mutually independent round ink dots, which are arranged in an array.

3. The clock structure enabling highly uniform distribution of illuminating light as claimed in claim 2, characterized in that the acrylic plate and the light uniforming paper are formed at a central area with a second through hole and a third through hole, respectively, to correspond to the first through hole on the dial.

4. The clock structure enabling highly uniform distribution of illuminating light as claimed in claim 3, characterized in that a sheet of rigid polypropylene (PP) synthetic paper is provided between the case frame and the acrylic plate; and the rigid PP synthetic paper having a white upper surface and being provided at a central area with a fourth through hole corresponding to the first through hole.

5. The clock structure enabling highly uniform distribution of illuminating light as claimed in claim 4, characterized in that the circuit board has a positive wire, a negative wire and a plurality of branch circuits; the branch circuits being connected in parallel and therefore having the same voltage across them; and the branch circuits respectively including one LED light and one resistor connected to the LED light in series.
